(19) United States
(12) Patent Application Publication
(10) Pub. No.: US 2004/0209511 A1
(43) Pub. Date: Oct. 21, 2004

(54) Electrical plug with protection cover

(76) Inventor: Sheng Hsin Liao, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/419,210

(22) Filed: Apr. 21, 2003

(51) Int. Cl. H01R 4/24

(52) U.S. Cl. 439/418

(57) ABSTRACT

An electrical plug of the invention has a plug body, a plurality of terminals, a connector, a plurality of conductive wires and a protection cover. A plurality of terminal slots is formed in a front side of the plug body for respectively receiving a plurality of terminals. A sleeve is formed on a rear side of the connector, and a plurality of wire slots is formed in a front side of the connector. The conductive wires penetrate through the sleeve of the connector and are respectively fastened inside the wire slots. The conductive wires are electrically connected to the terminals after the terminals respectively pierce the conductive wires. The protection cover is mounted on the connector to cover the resilient element of the plug body.

### BACKGROUND OF THE INVENTION

1. Field of the Invention

The invention relates to an electrical plug having a protection cover and, more particularly, an electrical plug having a protection cover that can electrically connect a plurality of conductive wires and be manufactured with a reduced production cost.

2. Description of the Related Art

Referring to FIG. 1, a conventional electrical plug used to electrically connect a plurality of conductive wires is suitable for connecting computer or telephone lines. The electrical plug includes a plug body 10a on a top of which a resilient element 11a is mounted for positioning. A plurality of terminals 12a is movably mounted in a bottom of the plug body 10a in a manner to move in a lengthwise direction within a short distance. Between the tops of each terminal 12a and the body 10a is mounted a connector 13a having a plurality of square slots 14a for external communication. The opened sides of square slots 14a respectively correspond to the terminals 12a, so that the terminals 12a insert into the connector 13a through the square slots 14a. The connector 13a further has a plurality of grooves (not shown).

When a plurality of conductive wires 20a are to be connected to the plug, the conductive wires 20a are inserted into the grooves of the connector 13a from a rear side of the body 10a. The terminals 12 are inserted into the connector 13a through the square slots 14a to pierce the conductive wires 20a, and thereby electrically connect with the conductive wires 20a.

In the above plug, the resilient element 11a protrudes from the body 10a and thus is likely to be damaged by, for example, bumping or bending, which may reduce the service life of the plug.

### SUMMARY OF THE INVENTION

It is therefore an object of the invention to provide an electrical plug with a protection cover mounted on a connector thereof. The protection cover covers a resilient element of the plug body to protect the resilient element from impact or damaging vibrations, which thereby improves the service life of the electrical plug.

To accomplish the above and other objectives, an electrical plug of the invention includes a plug body, a plurality of terminals, a connector, a plurality of conductive wires and a protection cover. The plug body has an internal accommodating space and an external surface on which is mounted a resilient element. A plurality of terminal slots is formed in a front side of the plug body to communicate with the accommodating space. Each of the terminals is inserted into a corresponding terminal slot. The connector is located inside the accommodating space of the plug body. A sleeve is formed on a rear side of the connector, and a plurality of wire slots are formed in a front side of the connector. The conductive wires penetrate through the sleeve of the connector and are respectively fastened inside the wire slots. The conductive wires are electrically connected to the terminals after the terminals respectively pierce the conductive wires. The protection cover is mounted on the connector to cover the resilient element of the plug body.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a cross-sectional view of a conventional electrical plug;

FIG. 2 is an exploded view of an electrical plug having a protection cover according to a first embodiment of the invention;

FIG. 2A is a perspective view of a connector of an electrical plug according to a first embodiment of the invention;

FIG. 3 is an exploded view of an electrical plug in which conductive wires are connected to the connector according to a first embodiment of the invention;

FIG. 3A is an enlarged view of part A of FIG. 3;

FIG. 4 is a perspective of an electrical plug according to a first embodiment of the invention;

FIG. 5 is a cross-sectional view of an electrical plug connected to terminals according to a first embodiment of the invention;

FIG. 6 is a cross-sectional view of an electrical plug in which a terminal is pressed down inside a corresponding terminal slot according to a first embodiment of the invention;

FIG. 7 is an exploded view of an electrical plug according to a second embodiment of the invention;

FIG. 8 is a cross-sectional view of an electrical plug according to a second embodiment of the invention;

FIG. 9 is an exploded view of an electrical plug according to a third embodiment of the invention;

FIG. 10 is a perspective view of an electrical plug according to a third embodiment of the invention; and

FIG. 11 is a cross-sectional view of an electrical plug according to a fourth embodiment of the invention.

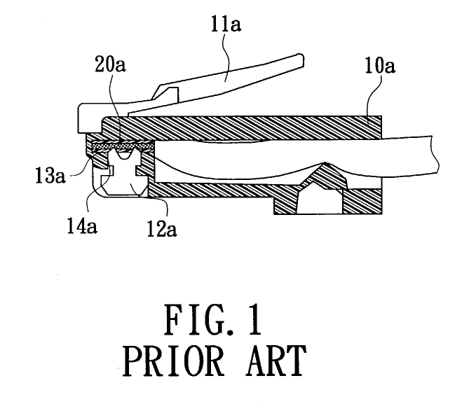

### DETAILED DESCRIPTION OF THE EMBODIMENTS

Wherever possible in the following description, like reference numerals will refer to like elements and parts unless otherwise illustrated.

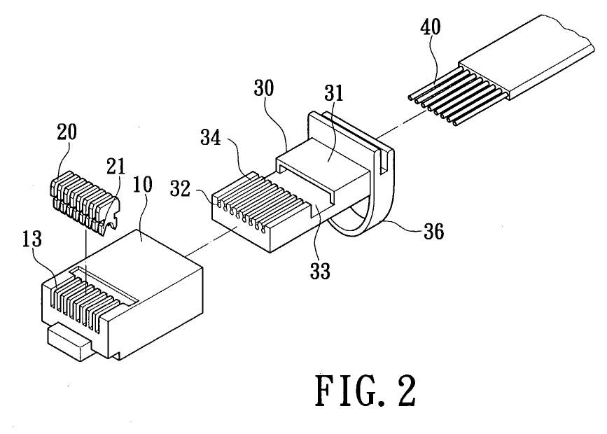

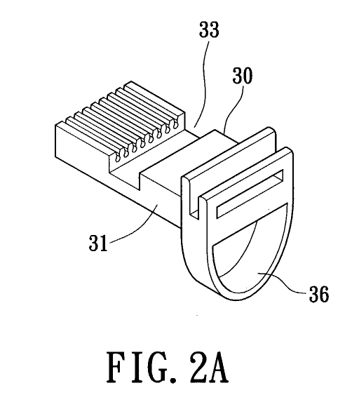

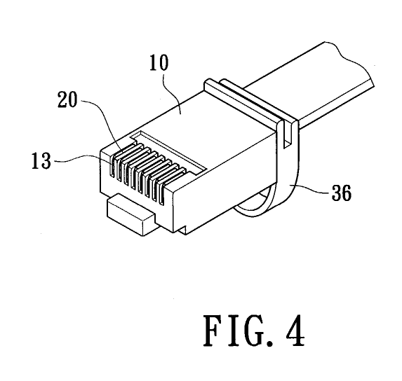

Referring to FIGS. 2-5, an electrical plug according to a first embodiment of the invention includes a plug body 10, a plurality of terminals 20, a connector 30 and a plurality of conductive wires 40.

The plug body 10 is made of an insulating material such as plastic. A resilient element 11 is mounted on an external surface of the plug body 10. An accommodating space 12 with an opened rear side is formed inside the plug body 10. A plurality of terminal slots 13 is formed in a front side of the plug body 10 to communicate with the accommodating space 12. The terminal slots 13 are regularly spaced by a constant separating distance.

The terminals 20 are made of a conductive material such as copper. Each of the terminals 20 is inserted into a corresponding terminal slot 13. Furthermore, each terminal 20 has a sharp tip 21 to connect electrically to a corresponding conductive wire 40.

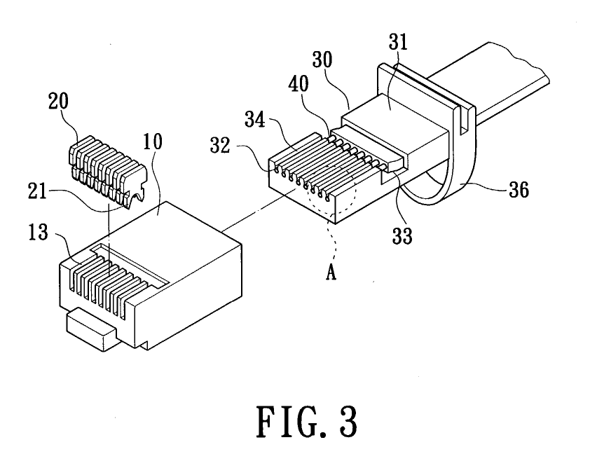

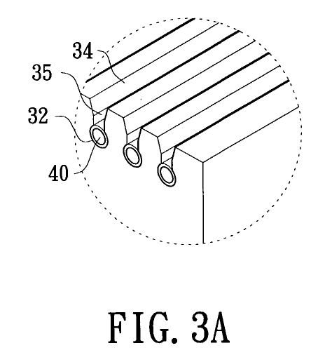

The connector 30 is made of an insulating material such as plastic. A sleeve 31 is formed on a rear side of the connector 30, as shown in FIG. 2A and FIG. 3A. The sleeve 31 has two open ends for receiving the conductive wires 40. A plurality of wire slots 32 is formed in a front side of the connector 30, with a recess 33 between the wire slots 32 and the sleeve 31. The wire slots 32 are equally spaced on the connector 30. An opening having a guiding incline surface 34 and a narrow bottom 35 is formed in the connector 30 to communicate with each wire slot 32. The wide mouth 34 further has a slanted sidewall. The narrow bottom 35 is narrower than an inner width of the wire slot 32. A protection cover 36 is further mounted on an external surface of the connector 35. The protection cover 36 is integrally formed with the connector 30. The protection cover 36 is a hollow casing through which is inserted the resilient element 11 of the body 10.

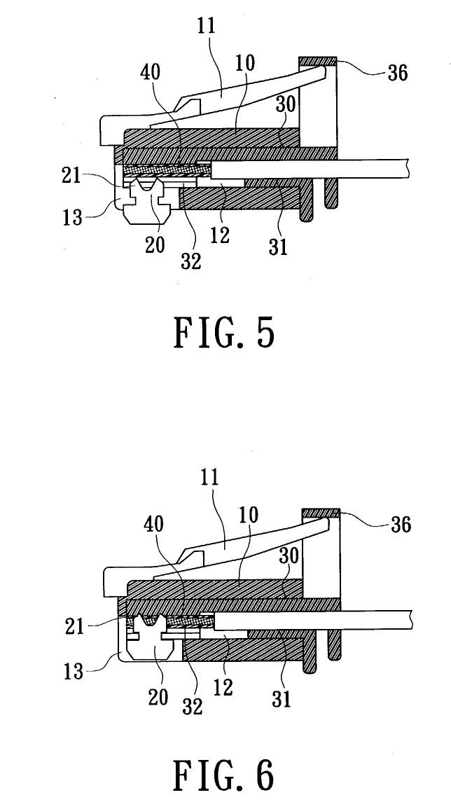

After the conductive wires 40 penetrate the sleeve 31 and the recess 33 from a rear side of the sleeve 31 of the connector 30, the conductive wires 40 are respectively distributed in the narrow bottoms 35. Then, the conductive wires 40 are fixedly fastened inside the corresponding wire slots 32 by applying an external force to press the conductive wires 40 into the wire slots 32. The conductive wires thereby are securely connected to the connector 30, as shown in FIG. 3. The connector 30 is inserted into the accommodating space 12 of the body 10 from a rear side of the accommodating space 12. Through snap fitting of the connector 30 in the accommodating space 12, the portions of the conductive wires 40 protruding from the connector 30 further insert inside the body 10 near its front side, as shown in FIG. 5. When the connector 30 is assembled with the body 10, the protection cover 3 covers the resilient element 11 of the body 10. Thereafter, the terminals 20 are pressed down inside the terminal slots 13 until the sharp tip 21 of each terminal 20 pierces the corresponding conductive wire 40 to achieve an electrical connection of the terminal 20 with the conductive wire 40, as shown in FIG. 6. An electrical plug with a protection cover is thereby constructed.

As described above, the conductive wires 40 are connected to the connector 30 before being electrically connected to the terminals 20 of the body 10. The guiding incline surface 34 of the wire slot 32 enables the conductive wire 40 to fasten easily inside the wire slot 32 through the narrow bottom 35, narrow bottom 35 being narrower than the inner width of the wire slot 32 and an outer diameter of the conductive wire 40, respectively. The conductive wires 40 fastened inside the wire slots 32 thereby are prevented from slipping away from the wire slots 32.

The protection cover 3 mounted on the external surface of the connector 30 covers the resilient element 11 of the body 10 when the connector 30 is assembled with the body 10. The resilient element 11 is thereby protected against external impact or vibrations, which advantageously prolongs the service life of the electrical plug.

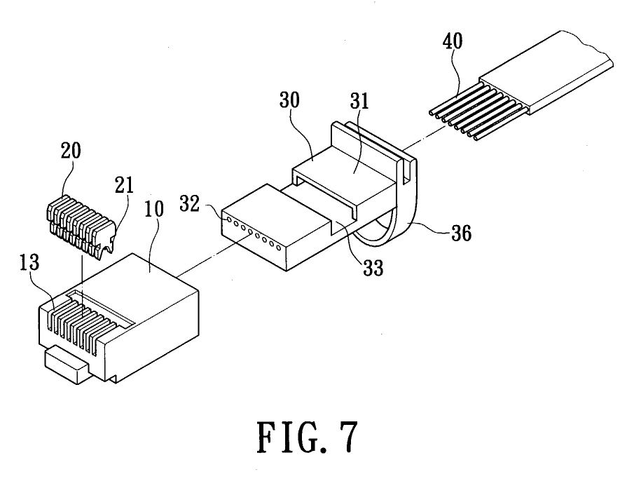

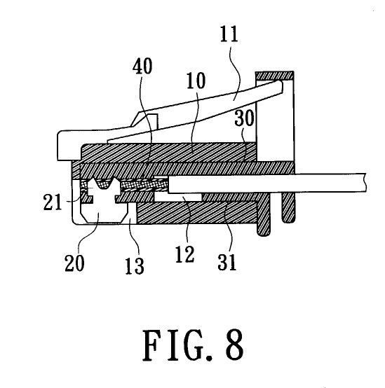

Referring to FIG. 7 and FIG. 8, the wire slots 32 in the front side of the connector 30 can have a cylindrical shape with two open ends. In this case, the conductive wires 40 are respectively inserted the corresponding wire slots 32 from their rear sides to connect electrically to the connector 30. With snap fitting of the connector 30 to the accommodating space 12 of the body 10, the conductive wires 40 connected to the connector 30 are firmly placed inside the body 10. Then, the terminals 20 are respectively pressed down in the corresponding terminal slots 13 until they pierce the conductive wires 40, which thereby electrically connect the terminals 20 to the conductive wires 40.

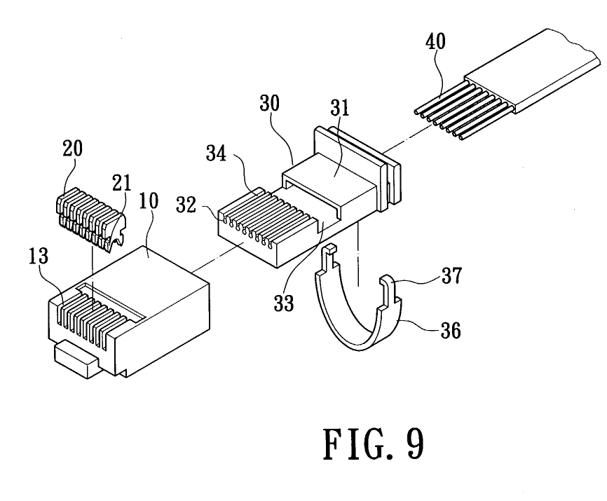

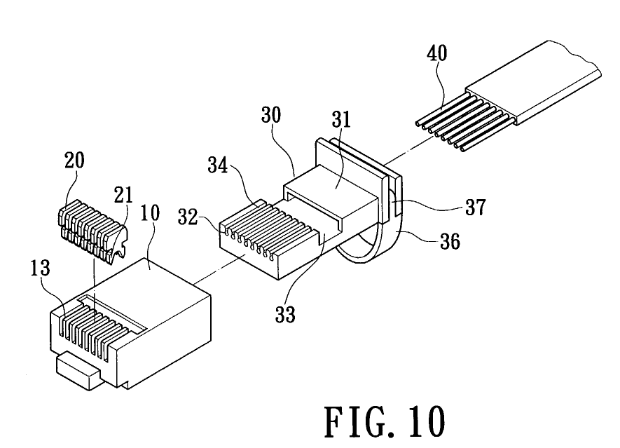

Referring to FIG. 9 and FIG. 10, the protection cover 3 can be detachably mounted on the connector 30. In this case, snapping parts 37 are further provided at opposite ends of the protection cover 36 to snap fit with the connector 30. When the connector 30 is assembled with the body 10, the protection cover 3 covers and protects the resilient element 11 of the body 10.

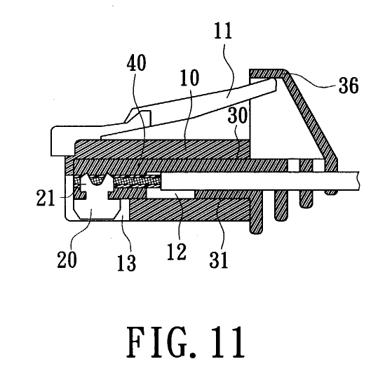

Referring to FIG. 11, the protection cover 3 can be a hollow casing with an open front end and a closed rear end.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An electrical plug having a protection cover, comprising:
a plug body, having an internal accommodating space and an external surface having a resilient element thereon, wherein a plurality of terminal slots is formed in a front side of the plug body to communicate with the accommodating space;
a plurality of terminals, each of the terminals being inserted into a corresponding terminal slot;
a connector, located inside the accommodating space of the plug body, wherein a sleeve is formed on a rear side of the connector and a plurality of wire slots is formed in a front side of the connector;
a plurality of conductive wires, penetrating through the sleeve of the connector and respectively fastened inside the wire slots, wherein the conductive wires are electrically connected to the terminals after the terminals respectively pierce the conductive wires; and
a protection cover, mounted on the connector to cover the resilient element of the plug body, said protection cover having a substantially semi-circular shape and receiving and protecting a free end of said resilient element.

2. The plug of claim 1, wherein the accommodating space of the plug body has an open rear end.

3. The plug of claim 1, wherein each terminal has a sharp tip to pierce a corresponding conductive wire to achieve electrical connection.

4. The plug of claim 1, wherein each of the wire slots has a pair of side walls, said pair of side walls defining an opening, and a conductive wire is placed within the opening of each of the wire slots.

5. The plug of claim 4, wherein the wide mouth of the wire slot has a slanted sidewall.

6. The plug of claim 4, wherein the wire slot has a bottom narrower than an open upper region of the wire slot.

7. The plug of claim 1, wherein the sleeve of the connector has two open ends.

8. (Canceled).

9. The plug of claim 1, wherein a recess is formed between the wire slot and the protection cover.

10. The plug of claim 1, wherein the protection cover is integrally formed with the connector.

11. The plug of claim 1, wherein the protection cover snap fits with the connector.
